(19) United States
(12) Patent Application Publication
(10) Pub. No.: US 2018/0137475 A1
(43) Pub. Date: May 17, 2018

(54) SYSTEM AND METHOD FOR PROVIDING REAL-TIME INVENTORY INFORMATION

(71) Applicant: OneMarket Network LLC, San Francisco, CA (US)

(72) Inventor: James Arthur Wilson, San Francisco, CA (US)

(73) Assignee: OneMarket Network LLC, San Francisco, CA (US)

(21) Appl. No.: 15/811,980

(22) Filed: Nov. 14, 2017

Related U.S. Application Data
(60) Provisional application No. 62/422,528, filed on Nov. 15, 2016.

(51) Int. Cl. G06Q 10/00; G06K 17/00; G06K 7/10

(52) U.S. Cl. CPC G06Q 10/20; G06K 7/10297; G06K 17/0022

(57) ABSTRACT

Disclosed are systems, methods, and devices for providing real-time inventory information. In one embodiment, the method comprises receiving a catalog of products offered for sale by one or more merchants; generating in-store catalogs for each of the one or more merchants, an in-store catalog representing products sold by a store operated by a merchant and an inventory count for each product sold by the store; receiving a product request from a user; identifying one or more related products based on the product request, each of the one or more related products being associated with a store; determining inventory counts associated with each of the one or more related products based on the in-store catalogs associated with the one or more related products; generating a list of in-stock products based on the inventory counts; and transmitting the list of in-stock products to the user in response to the product request.

### CLAIM OF PRIORITY

This application claims priority under 35 U.S.C. §119(e) of U.S. Provisional Patent Application Ser. No. 62/422,528, filed Nov. 15, 2016, entitled “SYSTEM AND METHOD FOR PROVIDING REAL-TIME INVENTORY INFORMATION”, which is hereby incorporated by reference in its entirety.

### COPYRIGHT NOTICE

This application includes material that may be subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND

Merchants and shopping centers were required to manually record and monitor inventory levels of products sold by merchants prior to the use of electronic systems. In order for customers to determine if a merchant currently had a product in stock customers were first required to remember products of interest and then required to either visit a store or contact the store (e.g., via phone) to inquire as to the inventory status of products the customer desired to purchase. These methods suffer from numerous inefficiencies. First, manual inventory management was subject to human error and miscalculation. Second, inventory amounts are frequently in flux due to new shipments and returns. Thus, customers may be informed that a product is not available while the product may be returned shortly afterwards. In this instance, the customer would assume the merchant does not have a product in stock when, in reality, the merchant does have the product in stock. Third, there was no feasible way to keep customers abreast of inventory changes in a real-time manner.

Many techniques have currently attempted to remedy inventory management problems. In 1974, the first Universal Product Code (“UPC”) marked item was scanned allowing for programmatic tracking of products. Around the same time frame, early ancestors of radio-frequency identification (“RFID”) were beginning to take shape. RFID utilizes electromagnetic fields to identify and track objects equipped with RFID tags. While related to similar goals, RFID improves upon optical barcodes by removing the requirement of line-of-sight transmission. With the improvement of wide area networks, RFID technology has been utilized to coordinate the tracking of items equipped with RFID tags on a global scale.

Despite these improvements in inventory management, current systems fail to utilize the data collected by inventory management systems to improve customer-facing systems and applications. Specifically, inventory management data is currently not utilized to improve electronic commerce solutions and provide real-time updates to customers.

Thus a need currently exists in the art to utilize RFID-based inventory management systems to provide real-time updates to customers.

### BRIEF SUMMARY

To remedy the aforementioned deficiencies, the disclosure presents systems, methods, and devices for providing real-time inventory information.

In one embodiment, the disclosure describes a method for providing real-time inventory information. In this embodiment, the method comprises receiving a catalog of products offered for sale by one or more merchants; generating in-store catalogs for each of the one or more merchants, each in-store catalog representing products sold by a store operated by a merchant and an inventory count for each product sold by the store; receiving a product request from a user; identifying one or more related products based on the product request, with each of the one or more related products being associated with a store; determining inventory counts associated with each of the one or more related products based on the in-store catalogs associated with the one or more related products; generating a list of in-stock products based on the inventory counts; and transmitting the list of in-stock products to the user in response to the product request.

In one embodiment, the disclosure describes a system for providing real-time inventory information. In this embodiment, the system comprises one or more processors and a non-transitory memory which stores computer-executable instructions therein that, when executed by the one or more processors, will cause the system to receive a catalog of products offered for sale by one or more merchants; generate in-store catalogs for each of the one or more merchants, each in-store catalog representing products sold by a store operated by a merchant and an inventory count for each product sold by the store; receive a product request from a user; identify one or more related products based on the product request, with each of the one or more related products being associated with a store; determine inventory counts associated with each of the one or more related products based on the in-store catalogs associated with the one or more related products; generate a list of in-stock products based on the inventory counts; and transmit the list of in-stock products to the user in response to the product request.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a flow diagram illustrating a method for managing an in-store inventory using RFID tags according to some embodiments of the disclosure.

FIG. 2 is a flow diagram illustrating a method for providing search results including an in-store inventory indicator according to some embodiments of the disclosure.

FIG. 3 is a flow diagram illustrating a method for displaying inventory notifications on a mobile device according to some embodiments of the disclosure.

FIG. 4 is a flow diagram illustrating a method for generating routes based on an in-store inventory amount according to some embodiments of the disclosure.

FIG. 5 is a network diagram illustrating a system for presenting personalized map labels according to some embodiments of the disclosure.

FIG. 6 is a logical block diagram illustrating a server device for managing an in-store inventory using RFID tags according to some embodiments of the disclosure.

### DETAILED DESCRIPTION

The present disclosure will now be described more fully hereinafter with reference to the accompanying drawings, which form a part hereof, and which show, by way of illustration, certain example embodiments.

Systems and method for utilizing RFID-enabled inventory management systems to provide real-time updates to users are disclosed herein. In each of the embodiments, an RFID-enabled system tracks and updates inventory counts for stores. The system detects new shipments as well as returns and corresponding updates, in real-time or near real-time, the number of products available at each store and their locations therein.

By managing an inventory in real-time or near real-time, the systems and methods disclosed herein provide customers with real-time or near real-time insights into the availability of products they may be interested in. In one embodiment, systems and methods are provided which receive product search queries and update search results with real-time or near real-time inventory counts for each item such that a user can be informed, in real-time or near real-time, as to the availability of products.

In alternative embodiments, systems and methods are provided which provide users with maps of shopping centers or malls. In addition to providing map content and information regarding stores within the map, the systems and methods can overlay information regarding the inventory status of relevant products. Alternatively, or in conjunction with the foregoing, the systems and methods provide notifications regarding changes in inventory status of products of interest.

In alternative embodiments, systems and methods are provided which transmit directions to users based on products of interest and the inventory status thereof. In these embodiments, the systems and methods can intelligently route users to products they may be interested in based on determining that the products are currently in stock, saving users' time and energy.

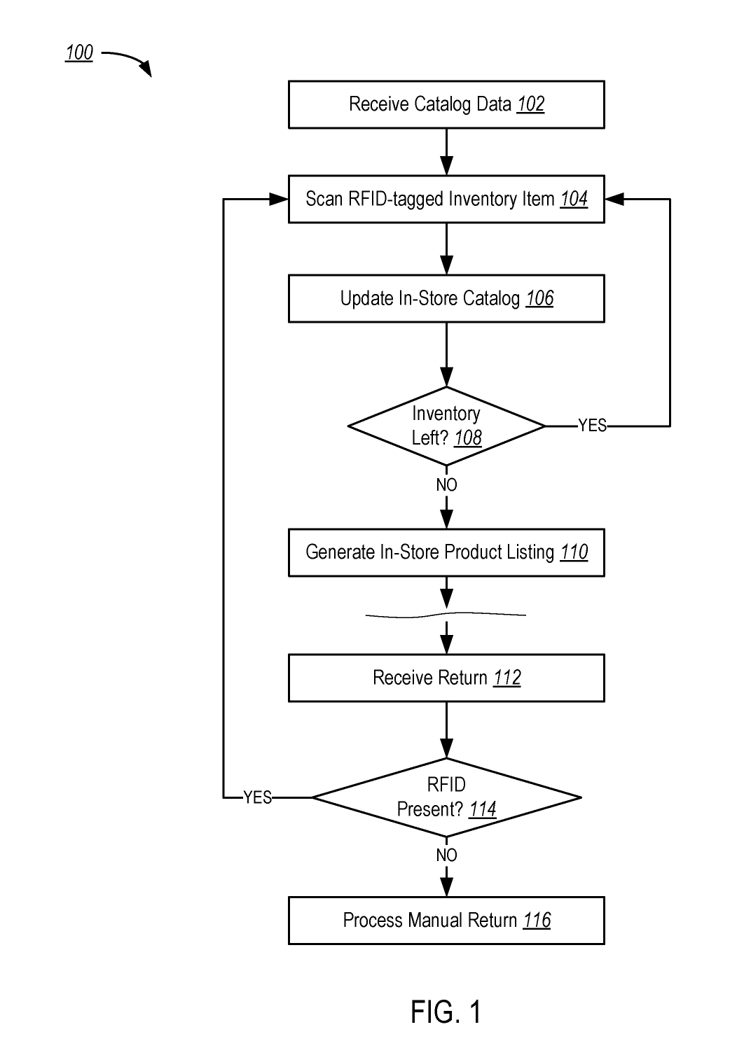

FIG. 1 is a flow diagram illustrating a method for managing an in-store inventory using RFID tags according to some embodiments of the disclosure. In step 102, the method 100 receives catalog data. In one embodiment, catalog data includes details regarding products sold or offered for sale by a merchant. For example, catalog information can include identifiers of products (e.g., UPC, SKU numbers), metadata regarding the products (e.g., manufacturer, description, material, packaging, color, size, etc.), one or more prices (e.g., standard price, sale prices, historical prices, etc.), etc. Alternatively, or in conjunction with the foregoing, catalog data is associated with a single location (e.g., store) or multiple stores.

In a first embodiment, catalog data represents the products within a merchant's catalog present within a given store (e.g., an inventory list). That is, the catalog data represents a subset of the total product data for a given merchant on a per-store basis. In this embodiment, the method 100 is executed for each store operated by a merchant.

In a second embodiment, catalog data represents aggregated data for multiple locations. For example, in some embodiments, catalog data includes a list of products and an indication of which stores have the products in stock (e.g., using a relational database). For example, catalog data can include Products A and B and an indication that Product A is present (e.g., in stock) at Stores X and Y and Product B is present at Stores Y and Z.

In yet another embodiment, catalog data comprises aggregated catalog data from multiple merchants (and/or multiple locations). For example, catalog data can include a list of products sold or offered for sale by multiple merchants operating one or more stores within a shopping complex such as a mall.

In step 104, the method 100 scans an RFID-tagged inventory item. In one embodiment, an inventory item corresponds to a product stored within catalog data received in step 102. In one embodiment, scanning an RFID-tagged item comprises utilizing an RFID reader to extract information regarding a product that includes an RFID tag. In alternative embodiments, the method 100 utilizes a UPC or SKU optical scanning device.

In one embodiment, an RFID tag stores information regarding a product. For example, in some embodiments, a product's RFID tag includes a SKU number or UPC code associated with the item. Alternatively, or in conjunction with the foregoing, an RFID tag includes product information such as that included within the catalog data (e.g., a merchant or store identifier). Alternatively, or in conjunction with the foregoing, an RFID tag additionally includes item-specific information such as return information, shipping information, customer feedback, etc.

In one embodiment, items with RFID tags are received as part of a store's usual shipments and/or deliveries. Alternatively, or in conjunction with the foregoing, items with RFID tags are received as part of a return process as described more fully in connection with steps 112 through 116.

In step 106, the method 100 updates an in-store catalog 106. In one embodiment, the catalog data comprises an entire catalog of a merchant or store. For example, the catalog data can comprise a canonical list of products offered for sale by a merchant, regardless of actual inventory amounts per-store.

In one embodiment, the method 100 initializes an in-store catalog as a “blank” catalog having no items. In alternative embodiments, the method 100 initializes an in-store catalog with each of the products identified in the catalog data while simultaneously setting a stock count for each product to zero. In this manner, the method 100 begins operation with an “empty” or “blank” in-store catalog derived from the catalog data.

In one embodiment, updating an in-store catalog comprises incrementing a stock count for a given product associated with an RFID tag. In this manner, the method 100 updates, in real-time or near real-time, the inventory amounts of products stored in the in-store catalog. Alternatively, or in conjunction with the foregoing, updating an in-store catalog additionally comprises identifying a location associated with the product including the RFID tag.

In one embodiment, step 106 comprises updating a stock count for each item stored within the in-store catalog. For example, upon check out, a merchant scans the RFID tag associated with an item in step 104. In step 106, the method 100 determines the associated product in the in-store product catalog and decrement a stock count due to the item being purchased and thus leaving the inventory.

In step 108, the method 100 determines if any inventory is remaining. In one embodiment, steps 104 and 106 are repeated for each item of inventory present within a store. In this manner, steps 104 through 108 allow a merchant or store to scan each item in inventory and update an in-store catalog accordingly.

In step 110, the method 100 generates an in-store product list. In one embodiment, the in-store catalog updated in steps 104 through 108 is supplemented with additional details regarding the products such as reviews, links to product web pages, etc. In alternative embodiments, this information is added to the in-store catalog during step 106. In alternative embodiments, the method 100 additionally removes any items that have been discontinued or will not be in-stock in the future.

In step 112, the method 100 receives a return. In one embodiment, returns are received by individual merchants or by a shopping center or mall. In one embodiment, the method 100 utilizes a robotic delivery device to handle returns as described in commonly owned application Ser. No. 14/946,635 entitled “Robotic Systems and Methods,” the disclosure of which is incorporated herein by reference.

In step 114, the method 100 determines if the item contains an RFID tag. In one embodiment, an RFID tag is placed within the returned item itself. In alternative embodiments, the RFID tag is placed within packaging associated with the returned item.

If an RFID tag is present, the method 100 scans the RFID tagged item (step 104), updates an in-store catalog (step 106), and updates an in-store product list (step 110).

As discussed previously, the method 100 receives catalog data in step 102 and generates a plurality of “in-store” catalogs based on the received catalog data. For example, upon receiving or generating catalog data for multiple stores, the method 100 segments the catalog data into one or more catalogs associated with items sold within certain stores. In this manner, the method 100 creates multiple “catalogs” from a single catalog data set. Further, the method 100 filters the catalog data to only utilize those items which are known to be “in-store” at the time of receiving the catalog.

Upon detecting an RFID tag in step 114, in step 104 the method 100 scans a return item received at a shopping center. In this example, the method 100 scans the RFID tag of the return item to identify a merchant or store and a product code (e.g., SKU or UPC number). The method 100 then identifies the corresponding inventory product in the in-store catalog and increment a stock count due to the returned item.

In step 116, the method 100 processes a manual return if an RFID tag is not detected. In one embodiment, a returned item does not contain an RFID tag and thus the method 100 is not able to process the item based on RFID data. In this embodiment, the method 100 utilizes other identifiers to identify the returned item (e.g., optical scanning of a UPS or SKU number). Upon detecting the identity of the product using these means, the method 100 continues to update an in-store catalog as discussed above.

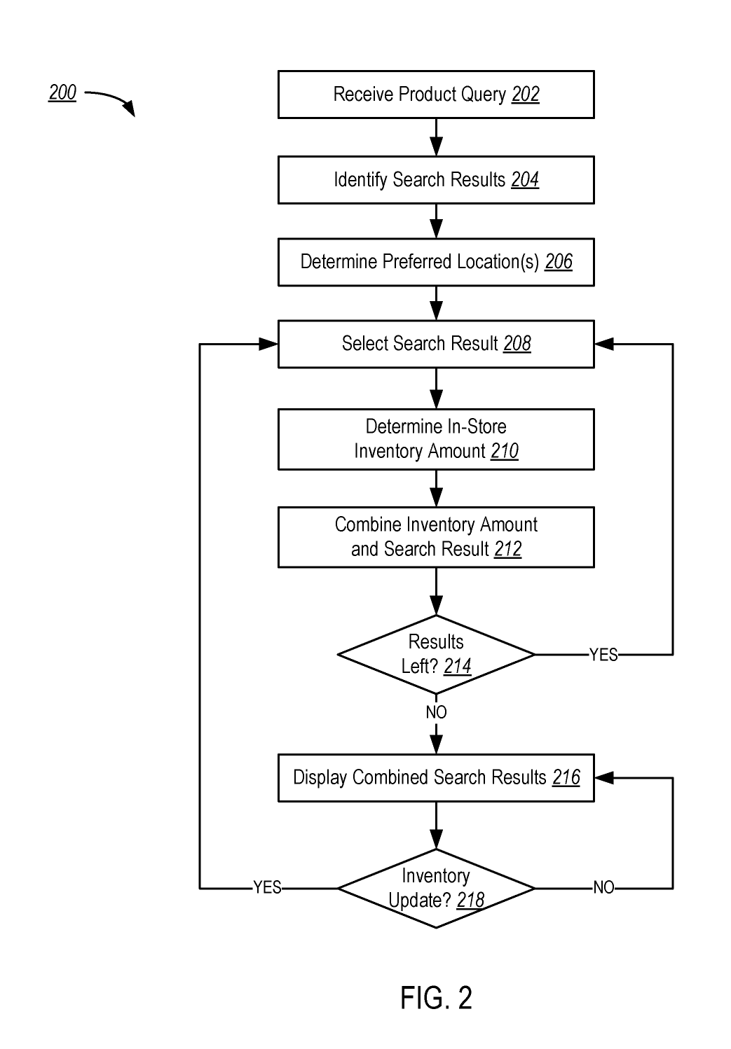

FIG. 2 is a flow diagram illustrating a method for providing search results including an in-store inventory indicator according to some embodiments of the disclosure. In step 202, the method 200 receives a product query. In one embodiment, a product query comprises a request for search results received from a web application or mobile application. For example, a product query comprises an HTTP or other network-based request that includes an identifier of a product. In one embodiment, an identifier of a product comprises a textual search term.

In step 204, the method identifies search results based on the product query. In one embodiment, identifying search results comprises using the product query to identify one or more products present within catalog data. In one embodiment, catalog data comprises catalog data for a single store. In alternative embodiments, catalog data comprises catalog data for multiple stores (e.g., when implemented by a shopping center or mall). In alternative embodiments, catalog data comprises catalog data for multiple stores and multiple shopping centers or malls. In one embodiment, catalog data is stored within a database and retrieval of records from the database based on a textual product query is performed using any database retrieval mechanisms known in the art.

In one embodiment, search results include multiple pieces of information relating to the product query. Information in the search results includes store names, product matches, store locations, store operating hours, product prices, reviews, etc.

In step 206, the method 200 determines preferred locations of the user associated with the product query. In one embodiment, a preferred location is determined based on the detected location of the user. For example, the user can additionally transmit an indication of the user's location such as geographic coordinates or an identifier associated with a predefined region (e.g., a shopping center) when using a mobile application to submit a product query. In this embodiment, the method 200 identifies the shopping center nearest to the user as the preferred location,

In alternative embodiments, the method 200 identifies preferred locations based on a user profile. For example, a user can submit a product query via a web application while at home. In this embodiment, the user may not be near a shopping center (or store). The method 200 in this embodiment utilizes a profile associated with the user that includes a list of preferred locations shopping centers or individual stores). In this embodiment, the method 200 selects those locations in the user's profile as the preferred locations.

In steps 208 through 214, the method 200 selects and inspects each search result in order to supplement the search results with information generated during an inventory management process. In one embodiment, the inventory management process includes the methods described in connection with FIG. 1.

In step 210, the method 200 determines in in-store inventory amount associated with a search result. In one embodiment, determining an in-store inventory amount comprises identifying a merchant or store associated with the search result (e.g., a product) and identifying an in-store catalog associated with the merchant. The method 200 then queries the in-store catalog using a product identifier (e.g., UPC, SKU, etc.) to retrieve an inventory count associated with the specific product at the specific location.

In step 212, the method 200 combines the determined inventory amount with the selected search result. In one embodiment, combining the determined inventory amount comprises placing the inventory amount near the original search result. For example, the method 200 can update a search result template to include a textual representation of the inventory count near the product name or the store name or location.

In step 216, the method 200 displays the combined search results. In one embodiment, displaying the combined search results comprises aggregating the individual search result templates into a single combined template which includes a predefined search results layout. In some embodiments, displaying combined search results additionally comprises transmitting the combined search results template to a user via a network connection. Alternatively, or in conjunction with the foregoing, displaying combined search results comprises transmitting a structured representation of the combined search results (e.g., in JSON or XML format) to an application, such as a mobile application.

In step 218, the method 200 determines whether an inventory amount associated with the search results has been updated. As discussed in connection with FIG. 1, an in-store catalog is constantly in flux due to updates in inventory counts caused by new shipments and returns, in response to these changes, merchants frequently update in-store catalogs with real-time inventory counts.

In one embodiment, the method 200 receives notifications of changes in inventory counts that affect the products identified in steps 202 and 204. In alternative embodiments, the method 200 periodically polls an in-store catalog to determine if the inventory count associated with the products identified in steps 202 and 204 has changed.

If the inventory count associated with any of the products identified in steps 202 and 204 has changed, the method 200 updates the search results accordingly using techniques similar or identical to those discussed in connection with steps 210, 212, and 214.

Although described primarily in the context of search results, the method 200 can additionally be implemented in other contexts without significant modifications. For example, the method 200 can be utilized in the context of a “wish list” or list of favorited items. In this embodiment, users receive updated inventory counts using a wish list as “search results” in the context of the method 200. Alternatively, or in conjunction with the foregoing, the method 200 can be utilized by merchants themselves to receive real-time updates of inventory in response to product searches. For example, the method 200 can be utilized by clerks when assisting customers.

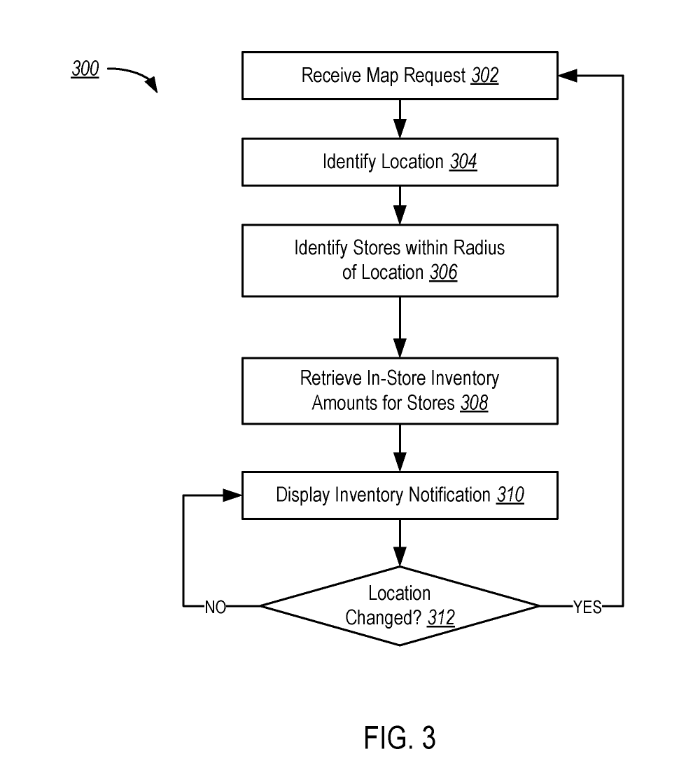

FIG. 3 is a flow diagram illustrating a method for displaying inventory notifications on a mobile device according to some embodiments of the disclosure. In step 302, the method 300 receives a map request. In one embodiment, a map request comprises a request for map content (e.g., image tiles representing a map of, for example, a shopping center) as well as data regarding locations within the area depicted by the map content.

In step 304, the method 300 identifies the location of the user or device that issued the map request. In one embodiment, the method 300 retrieves the location of the user based on geographic coordinates (e.g., latitude, longitude, altitude) included within the map request. In one embodiment, the location of the user or device is generated by a mobile application and included within the map request.

In step 306, the method 300 identifies stores within a predefined radius of the location. In one embodiment, the method 300 identifies a list of stores that appear within a rectilinear hounding area defining the map content associated with the user or device's location.

Examples of identifying map content and locations within map content are described in commonly owned application Ser. No. 15/340,666 entitled “System and Method for Presenting Optimized Map Labels,” incorporated herein by reference.

In step 308, the method 300 retrieves in-store inventory amounts for stores identified in step 306. In one embodiment, the method 300 identifies the list of stores in step 306 and issues a query to in-store catalogs associated with each of the stores, thus obtaining an inventory level or count for products associated with the stores.

In alternative embodiments, the method 300 only retrieves inventory amounts for products of interest to a user. For example, the method 300 only retrieves inventory amounts for products similar to products frequently or recently purchased by the user issuing the map request. Alternatively, or in conjunction with the foregoing, the method 300 only retrieves inventory amounts for products that are favorited by a user, or are in a user's “wish list.” Alternatively, or in conjunction with the foregoing, the method 300 only retrieves inventory amounts for products that have previously been searched for by users. In the above alternative embodiments, the method 300 first generates a list of product identifiers (such as SKU or UPC numbers) and queries each in-store catalog for the inventory amounts for each of the identified products.

In step 310, the method 300 displays an inventory notification to the user. In one embodiment, an inventory notification comprises a push notification informing the user that an identified product is currently in stock at a location within a predefined radius of the user's location. Alternatively, or in conjunction with the foregoing, displaying an inventory notification comprises displaying a label or other identifier on a map indicating inventory levels associated with identified products.

In step 312, the method 300 determines if the user or device's location has changed. In one embodiment, software running on a mobile device automatically transmits a notification that the device's location has changed beyond a set threshold. In this embodiment, the method 300 re-executes steps 302 through 310 in order to update inventory notifications based on the new location of the user or device.

The following non-limiting example is provided to further explain the method 300 in the context of a user navigating through a shopping center.

After entering a shopping center, a user launches a mobile application designed to provide a map for the shopping center. Upon opening the application, the application transmits a map request to a server in order to retrieve map-related data for the shopping center. The first map request includes the location of the user at a first position in the shopping center. Alternatively, or in conjunction with the foregoing, the map request additionally identifies the user issuing the request.

In response, a server retrieves information regarding the user position including map tiles and information regarding stores within a radius of the user's current location. The server additionally retrieves, for each store a list of products sold by the store (e.g., Stores A, B, and C) and inventory amounts for each product. In one embodiment, the server filters the product and inventory counts based on products that may be of interest to the user as discussed previously.

After identifying the products and inventory counts, the server transmits the map data, store information, and product/inventory information to the mobile application. In response, the mobile device displays the map and overlays some or all of the store information and product/inventory information. For example, the mobile application can display a notification that Product X is now available at Store B which appears within the map area displayed by the mobile device. Product X may have been chosen by the server based on the user's past searches for Product X and an indication that the user has not purchased Product X yet.

Subsequently, the user navigates throughout the shopping center. After moving a predetermined distance, the mobile application detects that an updated map is needed. In response, the mobile application transmits a second map request which may be similar to the first map request with an updated user location. Alternatively, or in conjunction with the foregoing, the second map request provides an indication of whether the previous store or product/inventory information was of use to the user. Product/inventory information may be of use to the user if the user completed a purchase of a product in the product/inventory information. Alternatively, or in conjunction with the foregoing, product/inventory information may be of use to the user if the user “likes” or dismisses the notifications. In some embodiments, the server updates a user's profile based on this feedback.

In response to a change in location, the server generates a list of stores and product/inventory information similar to the first response. Likewise, the server transmits the updated information to the mobile application and the information is displayed in a similar manner.

In one embodiment, the mobile application runs as a daemon process that passively transmits and receives the aforementioned information. In this embodiment, a user receives a visual, audio, and/or haptic notification of product/inventory information nearby, without the need to view the mobile application. For example, the user can receive a haptic notification when the daemon detects that the user is within five hundred feet of a store which has a product of interest in stock. In this manner, the mobile application and server non-intrusively notify the user of purchases that the user may otherwise not be aware of due to changing stock conditions.

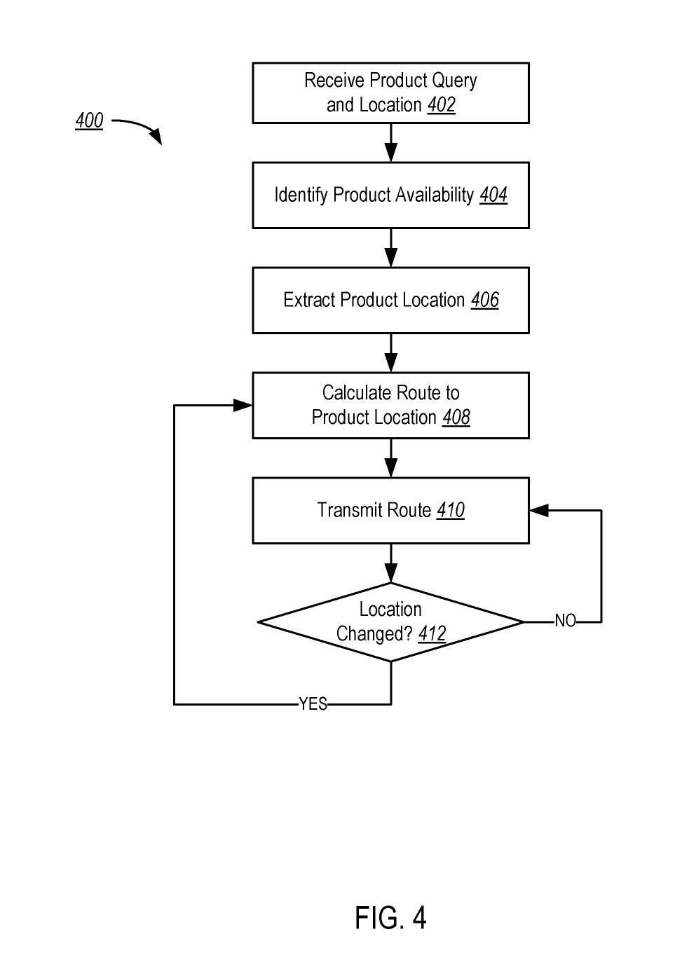

Alternatively, or in conjunction with the foregoing, the method 300 additionally transmits notifications regarding product/inventory information regardless of the user's location. For example, the method 300 can identify products of interest to the user within a shopping mall, regardless of the distance of the product to the user. The method 300 then can alert the user of products of interest and inventory amounts in order to inform the user that certain highly valued products are currently in stock. In some embodiments, a mobile application utilized in method 300 additionally can provide directions to products as described more fully in connection with FIG. 4.

FIG. 4 is a flow diagram illustrating a method for generating routes based on an in-store inventory amount according to some embodiments of the disclosure.

In step 402, the method 400 receives a product query and the location of a user. In one embodiment, receiving a product query comprises receiving a search request from a user of a mobile device. Alternatively, or in conjunction with the foregoing, a product query is generated programmatically based on an identification of a product of interest as discussed previously.

In step 404, the method 400 identifies product availability. As discussed previously, products can be offered for sale by multiple locations within, for example, a shopping mall. These locations are associated with in-store catalogs that include products and inventory counts. Thus, in step 404, the method 400 first identifies which locations are associated with the product in the product query. Next, the method 400 identifies which of these locations have a product inventory count greater than zero (i.e., indicating locations which have products in stock).

In step 406, the method 400 extracts the product location from the retrieved search results. In one embodiment, extracting a product location comprises selecting a store selling the product that is closest to the user's current location. In some embodiments, the product location is the same as the store location. Alternatively, or in conjunction with the foregoing, the product location further comprises a location within a store where the product is located. For example, for larger department stores, the product location additionally includes a section within the store where the product is, or should be, located. Alternatively, or in conjunction with the foregoing, the product location includes finer grained detail such as on which shelves or walls the product is located. In some embodiments, the product location includes multiple “levels” of location information (e.g., a store, a section within a store, and a shelf within a section). In this embodiment, the method 400 selects the finest grained location (e.g., a shelf) as the product location.

In step 408, the method 400 calculates a route to the product location. In one embodiment, calculating a route to a product comprises generating walking directions from the user's location to the product location. Alternatively, or in conjunction with the foregoing, directions can include driving or mass transit directions.

In step 410, the method 400 transmits the route to the user. In one embodiment, a mobile application displays the route on a mobile device enabling a user to navigate to the identified product. In alternative embodiments, the method 400 provides multiple routes to the product. In alternative embodiments, the multiple routes include alternative routes to the same store or product. In alternative embodiments, the multiple routes include routes to different stores offering the same product.

In step 412, the method 400 determines if the user or device's location has changed. In one embodiment, software running on a mobile device automatically transmits a notification that the device's location has changed beyond a set threshold. In this embodiment, the method 400 re-executes steps 408 through 412 in order to update inventory notifications based on the new location of the user or device.

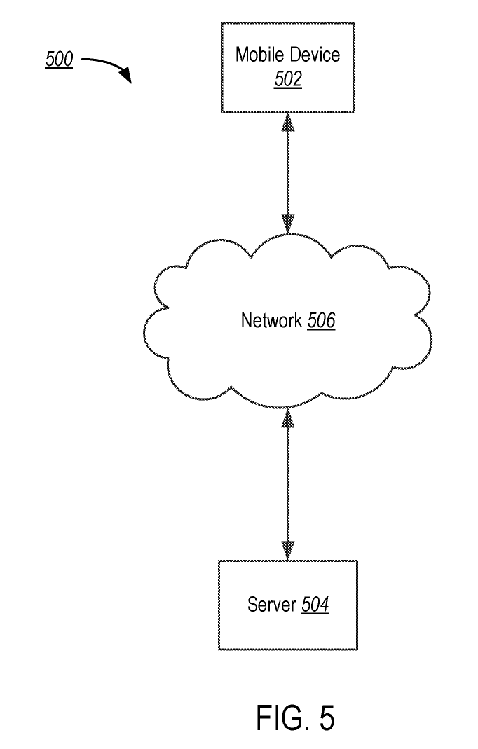

FIG. 5 is a network diagram illustrating a system for presenting personalized map labels according to some embodiments of the disclosure. As illustrated in FIG. 5, the system 500 includes a mobile device 502, server 504, and network 506. As illustrated in FIG. 5, a mobile device 502 comprises a computing device designed to be carried by a user. The mobile device 502 collects data generated by various hardware components present within the mobile device 502, such as GPS receivers, accelerometers, gyroscopes, or other devices capable of recording data regarding the movement or activity of the mobile device 502. Additionally, mobile device 502 displays map data (e.g., map tiles) in response to a user request to view a map. In addition to geographic detail, mobile device 502 displays labels and other information as an “overlay” of the map data. Mobile device 502 is equipped with one or more applications, such as a web browser or shopping application that submits queries for products on behalf of users and receives a list of products.

As discussed in more detail herein, mobile device 502 includes processing logic (e.g., a CPU) that receives and processes movement or location data. In some embodiments, the mobile device 502 receives data and pre-processes data prior to transmittal. In addition to recording and processing data, mobile device 502 transmits data, including location and event data, to other devices via network 506.

Although illustrated as a single network, in some embodiments, network 506 comprises multiple networks facilitating communication between devices. In one embodiment, the network 506 includes a wireless fidelity (“Wi-Fi”) network as defined by the IEEE 802.11 standards or equivalent standards. In this embodiment, the network 506 facilitates the transfer of location or event data from mobile device 502 to server 504. In an alternative embodiment, the network 506 comprises a mobile network such as a cellular network. In this embodiment, data is transferred between the illustrated devices in a manner similar to the embodiment wherein the network 506 is a Wi-Fi network. While described in isolation, network 506 can include multiple networks.

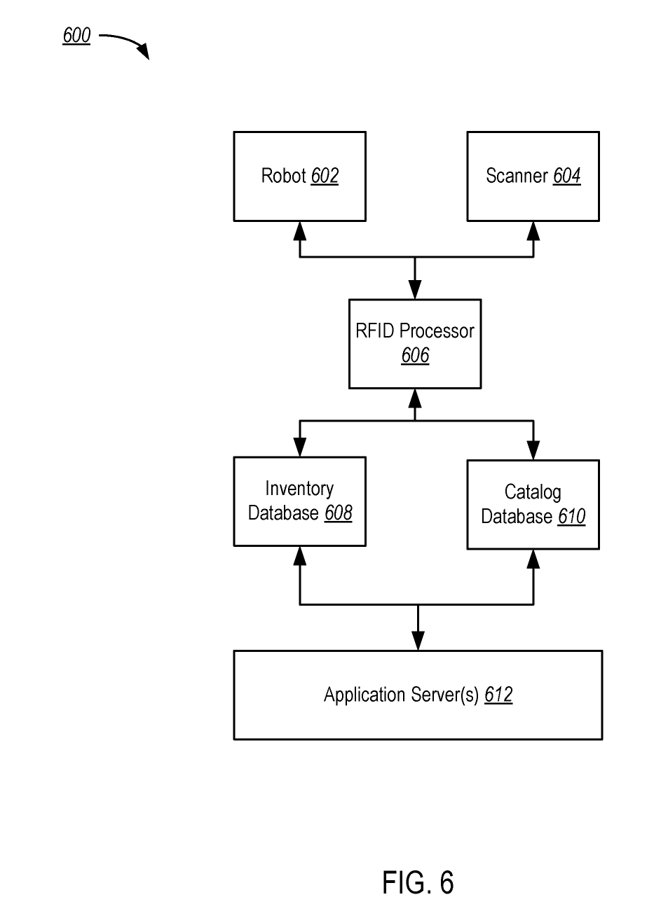

As discussed in more detail with respect to FIG. 6, server 504 receives requests from mobile device 502 and provides responses to such requests. In one embodiment, server 504 manages an inventory and catalog databases associated with one or more stores (for example, within a shopping mall or multiple shopping malls). In one embodiment, server 504 receives search requests for products sold by one or more stores and returns search results via a website or via an API (e.g., to a mobile application). In one embodiment, server 504 receives requests for map data from a mobile device 502 and provides map data in response. Alternatively, or in conjunction with the foregoing, server 504 receives user profile information and stores user profile information in one or more databases. Alternatively, or in conjunction with the foregoing, server 504 provides location details (e.g., item locations or routing information) to mobile device 502.

In alternative embodiments, server 504 additionally returns product information and inventory information associated with said products as discussed more fully with respect to FIGS. 2 through 3. Additionally, in some embodiments, server 504 provides direction information as discussed more fully with respect to FIG. 4.

FIG. 6 is a logical block diagram illustrating a server device for managing an in-store inventory using RFID tags according to some embodiments of the disclosure. As illustrated in FIG. 6, a device 600 includes a robot 602, scanner 604, RFID processor 606, inventory database 608, catalog database 610, and one or more application servers 612. Although illustrated as a single device, each of the components of device 600 can be located remote from one another (that is, each component resides on a separate server).

System 600 includes a robot 602. In one embodiment, robot 602 comprises a robotic delivery device that receives return items and delivers return items to individual stores within a shopping center. Examples of a robotic delivery device are described more fully in commonly owned application Ser. No. 14/946,635 entitled “Robotic Systems and Methods,” the disclosure of which is incorporated herein by reference.

System 600 includes a scanner 604. In one embodiment, scanner 604 comprises an RFID scanner. In alternative embodiments, scanner 604 comprises an optical scanner for scanning UPC, SKU, or other product identifiers. In one embodiment, scanner 604 is implemented as part of robot 602. Alternatively, or in conjunction with the foregoing, scanner 604 comprises a standalone scanner. Although illustrated as a single device, scanner 604 can comprise multiple scanners of disparate types as needed,

Both scanner 604 and robot 602 transmit data to RFID processor 606. In some embodiments, transmissions between scanner 604/robot 602 and RFID processor 606 are made using a wireless link such as a Wi-Fi network or cellular network. Alternatively, or in conjunction with the foregoing, scanner 604/robot 602 can transmit data to RFID processor 606 using a wired connection.

System 600 includes an RFID processor 606. In the illustrated embodiment, RFID processor 606 receives information regarding products from robot 602 and scanner 604. In one embodiment, RFID processor 606 receives information regarding return items from robot 602 such as product identifiers and store identifiers. In one embodiment, RFID processor 606 receives information regarding return items or deliveries from scanner 604.

In the illustrated embodiment, RFID processor 606 is communicatively coupled to inventory database 608 and catalog database 610. In some embodiments, RFID processor 606 parses product information received from robot 602 or scanner 604 and transmits notifications to databases 608 and/or 610. For example, in some embodiments, RFID processor 606 updates an inventory amount stored within inventory database 608.

Notably, in some embodiments, robot 602, scanner 604, and RFID processor 606 implement the inventory management methods described in connection with FIG. 1, the disclosure of which is incorporated herein in its entirety.

System 600 includes an inventory database 608. As described in connection with FIGS. 1 through 4, inventory database 608 stores inventory amounts for products and stores. In one embodiment, inventory database 608 comprises a relational database that stores a list of products with each product being associated with an inventory count and a store identifier. Additionally, a product in inventory database 608 represents an instance of a canonical product stored in catalog database 610.

System 600 includes a catalog database 610. In one embodiment, catalog database 610 stores a list of products offered for sale by merchants. In one embodiment, catalog database 610 does not include inventory amounts, but rather represents all products sold by a merchant (not a specific location).

The following example illustrates the use of databases 608 and 610 and is not intended to limit the storage mechanism to a particular embodiment. In this example, catalog database 610 includes a table for merchants and a table for stores, wherein stores are related to merchants via a foreign merchant_id key. Likewise, catalog database 610 includes a “products” table that stores a list of products, each having a product_id (e.g., a SKU, UPC, or other unique identifier). Products are related to merchants via an intermediate table that stores product identifiers and merchant identifiers. In this manner, catalog database 610 represents all products sold by a merchant as well as a list of all stores. Similarly, inventory database 608 includes a table storing products, wherein each product (e.g., row) stores a store identifier referencing a store in the catalog database 610 and an inventory count associated with the product and the store.

System 600 includes one or more application servers 612. Application servers 612 are communicatively coupled to databases 608 and 610 and retrieve and parse data from both databases 608 and 610. Application servers 612 additionally are communicatively coupled to user devices via a wide area network or local area network.

In one embodiment, application servers 612 receive product searches from users and display search results that include inventory levels for the search results. In this embodiment, application servers 612 implement all or part of the methods described in connection with FIG. 2, the description of which is incorporated herein by reference in its entirety.

Alternatively, or in conjunction with the foregoing, application servers 612 transmit notifications to the user device based on changing inventory levels. In this embodiment, application servers 612 implement all or part of the methods described in connection with FIG. 3, the description of which is incorporated herein by reference in its entirety.

Alternatively, or in conjunction with the foregoing, application servers 612 provide navigation directions to users based on products of interest to the user and inventory levels associated with the same products. In this embodiment, application servers 612 implement all or part of the methods described in connection with FIG. 4, the description of which is incorporated herein by reference in its entirety.

The subject matter described above may be embodied in a variety of different forms and, therefore, the application/description intends for covered or claimed subject matter to be construed as not being limited to any example embodiments set forth herein; example embodiments are provided merely to be illustrative. Likewise, the application/description intends a reasonably broad scope for claimed or covered subject matter. Among other things, for example, subject matter may be embodied as methods, devices, components, or systems. Accordingly, embodiments may, for example, take the form of hardware, software, firmware or any combination thereof (other than software per se). The description presented above is, therefore, not intended to be taken in a limiting sense.

Throughout the specification and claims, terms may have nuanced meanings suggested or implied in context beyond an explicitly stated meaning, likewise, the phrase “in one embodiment” as used herein does not necessarily refer to the same embodiment and the phrase “in another embodiment” as used herein does not necessarily refer to a different embodiment. The application/description intends, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium that can be used to tangibly store the desired information or data or instructions and that can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application that receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving a catalog of products offered for sale by one or more merchants;
generating in-store catalogs for each of the one or more merchants, an in-store catalog representing products sold by a store operated by a merchant and an inventory count for each product sold by the store;
receiving a product request from a user;
identifying one or more related products present in the in-store catalogs based on the product request;
determining inventory counts associated with each of the one or more related products based on the in-store catalogs;
generating a list of in-stock products based on the inventory counts; and
transmitting the list of in-stock products to the user in response to the product request.

2. The method of claim 1 further comprising:
detecting a returned product, the returned product including an RFID tag;
scanning the RFID tag and extracting a product identifier and a store identifier associated with the returned product; and
updating an inventory count associated with the product identifier and the store identifier.

3. The method of claim 1 wherein the product request comprises a search query.

4. The method of claim 3 wherein generating a list of in-stock products based on the inventory counts comprises generating a search results page that includes an identification of the one or more related products and one or more inventory counts associated with the one or more related products.

5. The method of claim 4 further comprising:
detecting a change in an inventory count associated with the one or more related products; and
updating the one or more inventory counts included on the search results page.

6. The method of claim 1 wherein the product request includes a map request, the map request including the location of a user.

7. The method of claim 6 wherein generating a list of in-stock products based on the inventory counts comprises:
generating a plurality of labels for the one or more related products, wherein a label includes a product identifier and an inventory count associated with the product identifier; and
displaying the plurality of labels on a map.

8. The method of claim 6 wherein transmitting the list of in-stock products to the user in response to the product request comprises transmitting a notification to a user, the notification indicating the availability of the one or snore related products.

9. The method of claim 6 further comprising:
selecting a first product from the one or more related products;
identifying a location of the first product;
calculating a route to the first product based on the location of the user; and
transmitting the route to the user.

10. The method of claim 9 wherein the location of the product comprises one of a store location, a section location, or a shelf or wall location.

11. A system comprising:
one or more processors; and
a non-transitory memory storing computer-executable instructions therein that, when executed by the one or more processors, cause the system to:
receive a catalog of products offered for sale by one or more merchants;
generate in-store catalogs for each of the one or more merchants, an in-store catalog representing products sold by a store operated by a merchant and an inventory count for each product sold by the store;
receive a product request from a user;
identify one or more related products present in the in-store catalogs based on the product request;
determine inventory counts associated with each of the one or more related products;
generate a list of in-stock products based on the inventory counts; and
transmit the list of in-stock products to the user in response to the product request.

12. The system of claim 11 wherein the instructions further cause the system to:
detect a returned product, the returned product including an RFID tag;
scan the RFID tag and extract a product identifier and a store identifier associated with the returned product; and
update an inventory count associated with the product identifier and the store identifier.

13. The system of claim 11 wherein the product request comprises a search query.

14. The system of claim 13 wherein generating a list of in-stock products based on the inventory counts comprises generating a search results page that includes an identification of the one or more related products and one or more inventory counts associated with the one or more related products.

15. The system of claim 14 wherein the instructions further cause the system to:
detect a change in an inventory count associated with the one or more related products; and
update the one or more inventory counts included on the search results page.

16. The system of claim 11 wherein the product request includes a map request, the map request including the location of a user.

17. The system of claim 16 wherein the instructions causing the system to generate a list of in-stock products based on the inventory counts comprises further include instructions causing the system to:
generate a plurality of labels for the one or more related products, wherein a label includes a product identifier and an inventory count associated with the product identifier; and
display the plurality of labels on a map.

18. The system of claim 16 wherein transmitting the list of in-stock products to the user in response to the product request comprises transmitting a notification to a user, the notification indicating the availability of the one or more related products.

19. The system of claim 16 wherein the instructions further cause the system to:
select a first product from the one or more related products;
identify a location of the first product;
calculate a route to the first product based on the location of the user; and
transmit the route to the user.

20. The system of claim 19 wherein the location of the product comprises one of a store location, a section location, or a shelf or wall location.
